(19) United States
(12) Patent Application Publication
(10) Pub. No.: US 2023/0214779 A1
(43) Pub. Date: Jul. 6, 2023

(54) On-Line Job Application Process Utilizing Configurable Rules to Dynamically Modify Job Application Workflow

(71) Applicant: Indeed, Inc., Austin, TX (US)

(72) Inventors: Jet Villegas, San Francisco, CA (US); Leon Liu, Chiyoda City (JP)

(73) Assignee: Indeed, Inc., Austin, TX (US)

(21) Appl. No.: 17/348,592

(22) Filed: Jun. 15, 2021

(51) Int. Cl. G06Q 10/10; G06N 20/00

(52) U.S. Cl. CPC G06Q 10/1053; G06N 20/00

(57) ABSTRACT

In at least on embodiment, a job application workflow system and method utilize a dynamic workflow engine to automatically and dynamically modify job application workflow to modify generation and presentation of a job application to a job applicant for a job with a job provider. The system and method respond to data input by the job applicant to dynamically modify a job application workflow in accordance to a set of rules. In at least one embodiment, the rule sets are of multiple types, such as general rules and job application specific rules, configured by multiple entities, such as a job provider and a job application host. This set of rules provided by the job provider and host for automatically generating the job application may be supplemented with conditions or additional rules previously set forth in the system.

### BACKGROUND

### Technical Field

The present invention relates generally to automatic real-time management of dynamic on-line job applications, and more specifically to a computer implemented method and system for utilizing configurable rules to automatically manage dynamic on-line job applications.

### Description of Related Art

Traditionally, job applicants completed paper job applications with pen or pencil. These job applications may have been general forms utilized by multiple employers or a more specialized form for a given employer. A job applicant could complete the job application and may attach a resume to that job application for consideration by the employer.

With the advent of computers and the internet, this job application process has been largely duplicated on-line. That is, an employer or a third party recruiting and/or hiring service may provide a static, electronic job application to a job applicant on-line. The job application process follows a static workflow so that the job applicant completes all the required data fields and provides any requested information, such as attaching a resumé. The job applicant then submits the completed application electronically for consideration by the employer or hiring service. As with paper job applications, such electronic job applications may be a general form utilized by multiple employers or a more specialized form for a given employer.

### SUMMARY

The illustrative embodiments of job application, dynamic workflow systems and processes provide a method, system, and/or non-transitory, computer usable program product for automatically managing dynamic on-line job applications including receiving, from a first computer system of a job provider representative, a set of configurable rules for presenting a job application to a job applicant; receiving, from a second computer system, an initiation of the job application from the job applicant; responsive to the initiation of the job application, automatically providing the job application to the first computer system of the job applicant in accordance with the set of configurable rules from the second computer system of the job provider representative; receiving information regarding the job applicant; and dynamically modifying the job application presented to the first computer system of the job applicant in response to the information regarding the job applicant.

### BRIEF DESCRIPTION OF THE DRAWINGS

The novel features believed characteristic of the job application, dynamic workflow systems and processes are set forth in the appended claims. The job application, dynamic workflow systems and processes itself, further objectives and advantages thereof, as well as a preferred mode of use, will best be understood by reference to the following detailed description of illustrative embodiments when read in conjunction with the accompanying drawings, wherein:

FIG. 1 provides a high level block diagram of a system utilizing configurable rules for automatically managing dynamic on-line job applications, in which various embodiments of the present disclosure may be implemented;

FIG. 2 provides a high level flow diagram for utilizing configurable rules to automatically manage dynamic on-line job applications, in which various embodiments of the present disclosure may be implemented;

FIGS. 3A and 3B provide block diagrams of an action and a rule and their components in which various embodiments of the present disclosure may be implemented;

FIG. 4 provides a high level block diagram of a job application which may be modified or redirected by configurable rules, in which various embodiments of the present disclosure may be implemented;

FIG. 5 provides a user interface page for a job provider to configure rules for modifying the job application, for setting forth the conditions for redirecting the job applicant, and for other desired effects on the job application process, in which various embodiments of the job application, dynamic workflow systems and processes may be implemented;

FIG. 6 provides a flow diagram of a job application presented to a job applicant in accordance with the selection made by a job provider representative as shown in FIG. 5, in which various embodiments of the present disclosure may be implemented;

FIG. 7 provides a block diagram of an illustrative data processing system in which various embodiments of the present disclosure may be implemented; and

FIG. 8 provides a block diagram of an illustrative network of data processing systems in which various embodiments of the present disclosure may be implemented.

### DETAILED DESCRIPTION

Processes and devices may be implemented and utilized for implementing configurable rules for automatically managing dynamic on-line job applications. These processes and apparatuses may be implemented and utilized as will be explained with reference to the various embodiments below.

In at least on embodiment, a job application workflow system and method utilize a dynamic workflow engine to automatically and dynamically modify job application workflow to modify generation and presentation of a job application to a job applicant for a job with a job provider. In at least one embodiment, “job application dynamic workflow” refers to dynamic modification of job application processes that include (i) modifying job application steps taken by a job applicant completing the job application, such as adding, removing, and reordering job application steps and (ii) redirecting a job applicant to a different job application relative to a current job application. The system and method respond to data input by the job applicant to dynamically modify a job application workflow in accordance to a set of rules. In at least one embodiment, the rule sets are of multiple types, such as general rules and job application specific rules, configured by multiple entities, such as a job provider and a job application host. This set of rules provided by the job provider and host for automatically generating the job application may be supplemented with conditions or additional rules previously set forth in the system. This set of rules utilized by the system dynamically modifies the job application workflow in response to information obtained or received from the job applicant or from third party data in real-time while that job applicant completes the job application. The job application workflow system and method can reorder job application processes, such as job applicant data requests, and redirect the job applicant to jobs more suitable to the job applicant by modifying the job application in real-time to, for example, match the job applicant to a job application that is more suitable to the job applicant's qualifications and aspirations.

The description of the job application workflow system and method herein utilize examples from a job search intermediary providing communications with and between job providers and job seekers to further enable others of ordinary skill in the art to understand the embodiments disclosed herein. The job application workflow system and method, including modifications and variations thereof, may be utilized in other hosted communication environments as will be apparent to those of ordinary skill in the art without departing from the scope and spirit of the described embodiments.

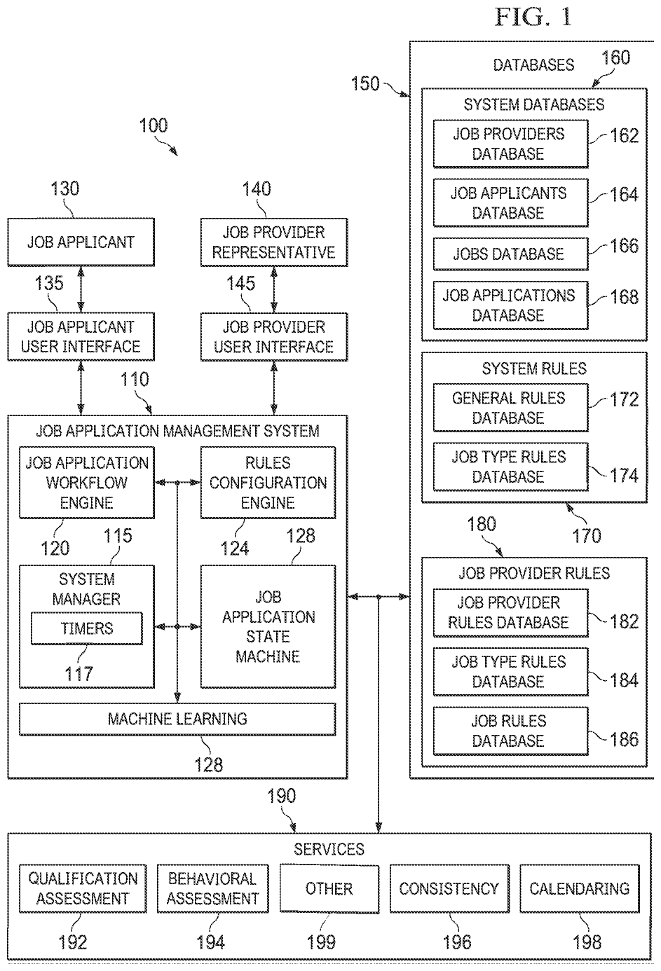

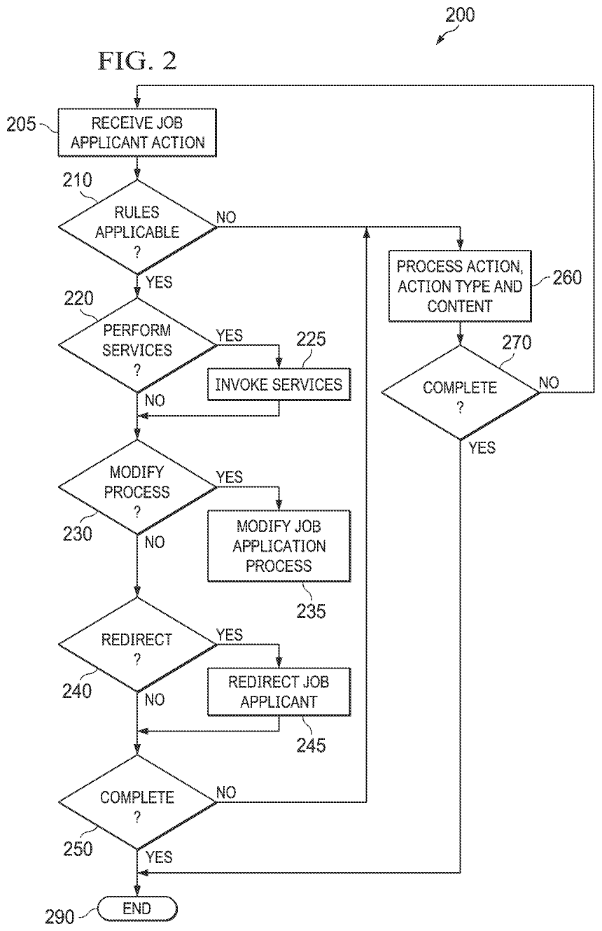

FIG. 1 provides a high level block diagram of a job application, dynamic workflow system 100 utilizing configurable rules for automatically managing dynamic workflow of on-line job applications. FIG. 2 provides a high level dynamic job application workflow process 200 utilized by at least one embodiment of the system 100 for utilizing configurable rules to automatically manage the dynamic workflow of on-line job applications. Referring to FIGS. 1 and 2, a job application dynamic workflow management system 110 manages a dynamic job application workflow process 200. The subsequent discussion describes a job application workflow process with reference to a single job applicant completing a job application, although many such job applicants may be completing job applications for various jobs concurrently.

Job application management system 110 interacts with a job applicant 130 in real-time through a job applicant user interface 135 on a first computer system to complete a dynamic on-line job application for a job. Job application management system also interacts with a job provider representative 140 in real-time through job provider user interface 145 on a second computer system to generate a set of rules for implementing the job application for the job. A job provider may be an employer seeking a job applicant employee, a general contractor seeking a job applicant contractor, a non-profit organization seeking a job applicant volunteer, etc. A job applicant may include, but not limited to, a job seeker, a job candidate, or other similar terms which may be utilized herein. Databases 150 are utilized to maintain a variety of information utilized and stored by job application dynamic workflow management system 110. Services 190 are also provided for job application dynamic workflow management system 110 in accordance with the set of rules. Services 190 may also directly access databases 150 as needed to perform services for job application, dynamic workflow system 110.

Job application management system 110 (also referred to herein as management system 110) may include a system manager 115, a job applications workflow manager 120, a rules configuration engine 124, a job application state machine 126 and a machine learning module 128. System manager 115 may be utilized for coordinating and managing the various components of management system 110 as well as their interaction with external components including user interfaces 135, 145 databases 150 and services 190. System manager 115 may include timers 117 for use as described herein. Job application workflow manager 120 (also referred to herein as workflow manager 120) manages the dynamic application process of job applicant 130 in accordance with the configurable rules. Rules configuration engine 124 manages the configuration of rules by job provider representative 140. Rules may include two primary components, a set of rule conditions and a set of rule actions. That is, if the rule conditions are met, then the rule actions are taken in response. A rule action may be one or more of a set of services. Job application state machine 126 (also referred to herein as state machine 126) may manage the state of each job application being processed. That is, state machine 126 keeps track of where a job applicant is within the job application process, which may be useful in determining which rules to apply and when to apply those rules. For example, certain rules may only apply to a request to complete a job application, the completion of a certain page within the job application, etc. State machine 126 may help distinguish where a job applicant is within the job application process for such rule application. State machine 126 may be placed internal to workflow manager 120 or internal to system manager 115. Alternatively, user interface 135 may also maintain a current state of the job application process and provide that information to workflow manager 120 as an action type or other indication. Machine learning module 128 may be utilized by rules configuration engine 124 to generate or modify certain rules, utilized by workflow engine 120 as a service, and utilized by system manager 115 for other operations. The utilization and coordination of these various components of management system 110 are described in greater detail herein.

Databases 150 include a variety of database utilized by management system 110 and services 190. These include system databases 160, system rules 170 and job provider rule 180. System databases 160 include job provider database 162, job applicant database 164, jobs database 166 and job applications database 168. Job provider database 162 includes information about various job providers that may be seeking to fill jobs with qualified job applicants. Job provider database may include a unique job provider identifier for each job provider as well as profile and other information regarding each job provider. Job applicant database 164 includes information about various job applicants that may be seeking jobs to apply for employment or other opportunities. Job applicant database 164 may include a unique job applicant identifier for each job applicant as well as profile and other information (e.g., a resume) regarding each job applicant. A temporary record may be created in this database for each job applicant that accesses the present job application, dynamic workflow system if they have not logged in or previously registered with the present job application, dynamic workflow system. Jobs database 166 may include information about each job currently or even previously available for filling with a qualified job applicant. Jobs database 166 may include a unique identifier for each job as well as qualifications and other parameters regarding each job. Jobs database 166 may also include a cross-reference with job provider database through the use of the job provider unique identifier. Job applications database 168 may include information about each job application generated by workflow engine 120 with input provided by job applicant 130 through job applicant user interface 135. Job applications database 168 may include with each job application a unique identifier for the corresponding job applicant, job provider and job. Job applications database 168 may also include other information provided by job applicant 130 during the job application completion process as managed by workflow engine 120. Alternative embodiments may organize such data differently, as may be appreciated by on of ordinary skill in the art.

Database 150 may include multiple sets of rules databases including system rules database 170 and job provider rules database 180. System rules database 170 may include several types of rules for use by workflow engine 120 including general rules 172 and job type rules 174. General rules 172 may be rules that are applicable across all jobs and job providers. For example, upon a job applicant first requesting to apply to a specific job, a job applicant qualification assessment service may be performed to compare the job applicant's known qualifications against the job criteria to assess the suitability of the job for the job applicant. This assessment may be utilized to take certain system based actions generally. For another example, if an applicant does not enter any data or take any actions for a threshold period of time such as may be determined by times 117, certain system based actions may be taken such as to further encourage a well-qualified candidate. Job type rules 174 may include rules utilized across all job providers for certain job types. For example, some job types typically have a high rejection rate, as may be determined by machine learning 128, and certain actions may be taken to encourage or discourage types of job applicants for such job types generally. Other types of system rules may be generated and utilized, such as may be identified as useful by machine learning 128. Job provider rules database 180 may include general job provider rules 182, job type rules 184 and job specific rules 186. General job provider rules 182 may include rules job provider 140 may have set up to be utilized for all jobs for that job provider. For example, job provider 140 may be in the defense industry and require a certain citizenship for employment in any job at that job provider. Job type rules 184 may include rules specific for a job type that is required for all job applicants for any job of that job type for job provider 140. For example, job provider 140 may require all job applicants for a certain job type to provide proficiency of certain computer skills. Job rules 186 may include rules specific to a particular job, but not all jobs of the same job type. For example, a particular job may ask whether the job applicant lives within a certain distance of a given job location. These rules may be organized by action type instead of by rule type. That is, the rules may be organized by whether the action taken by a job applicant is to initiate a job application, complete a page of the job application, etc. These rules may also be organized by tiers or other hierarchical organization. That is, if there are multiple rules that may apply to a given job application action, those rules may be implemented in an order set forth by tiers to avoid undesired results. Although rules are shown as either system rules or job provider rules, some combination thereof may also be utilized. For example, some job provider rules may include conditions automatically added by rules configuration system 124. Alternative embodiments may include other types of rules or rule organized differently, as may be appreciated by on of ordinary skill in the art.

Services 190 include various services which may be performed in response to any rules to provide information or analysis useful for carrying out those rules. That is, if certain rule conditions are met for a rule, then the rule action of that rule may be to perform one or more services. These services may be external to management system 110 as shown, or internal to management system 110 or a combination of internal and external. Services may include qualification assessment service 192, behavioral assessment service 194, consistency service 196, calendaring service 198, and other services 199. Qualification assessment service assesses the qualifications of the job applicant against the criteria of the job being applied to or against the criteria of multiple jobs open for job applicants. Behavioral assessment service 194 assesses the on-line behavior of the job application to determine whether the job applicant may be new to the job applicant process, whether the job applicant may be submitting excessive number of job applications in a limited time, or other behavioral patterns which may be useful. Consistency service 196 may assess whether the job applicant is consistent in their responses to job application questions or other fields within the job application. Calendaring service 198 may schedule an interview between a job applicant and the job provider. The job provider can identify interviewers and times they are available for interviewing job candidates for one or more open jobs, which is then utilized for calendaring interview with job candidates meeting certain rules. Other services 199 can include a multitude of other services that may be performed under certain conditions, such as a result of a rule, and may provide information useful for determining whether other rules may be met such as described herein.

FIG. 2 provides a high level flow diagram 200 for utilizing configurable rules to automatically manage dynamic on-line job applications, in which various embodiments of the present disclosure may be implemented. This high level flow diagram illustrates job applicant management system 110 managing the job application process of job applicant 130 completing an on-line application through on-line user interface 135. As explained herein, most of this job application process is managed by job application workflow manager 120. As the applicant completes portions of the on-line application, referred to herein as actions, these actions are processed in accordance with a set of configurable rules. This process may be initiated after a job applicant has searched for and found a job opening and has requested to complete a job application to submit for consideration for that job opening. This process is described with reference to the elements illustrated in FIG. 1.

In a first step 205, a discernable action performed job applicant on the on-line application through the user interface is received or otherwise detected. This discernable action may be an initial request to complete the on-line application, the completion of a field or a button selection on a page of the on-line application, the completion of the page of the on-line application (which may be indicated by selecting a next button), or the completion of the application (which may be indicated by the applicant selecting a finish or submit button). Other types of discernable actions that may be detected may include the user performing typing in text, clicking a mouse, or even not performing any action for a threshold period of time. Each action may include content associated with that action. For example, when a job applicant completes a page of an application, the content of that page may be associated with and utilized in association with the action. The types of discernable actions, referred to herein as action types, may be detected or otherwise determined and then acted upon depending on the configurable rules such as described below. For ease of reference, the discernable actions generally referred to in this figure are the completion of a page of an on-line application, although other types of discernable actions may be discussed as well.

Responsive to this job applicant action, in step 210, application workflow engine 120 automatically determines whether any of the various rules are applicable to the job applicant action. That is, the action and the content associated with that action is compared to the condition(s) of each of the rules to determine which rule(s) may apply to that job applicant action. This comparison may be reduced by utilizing the action type to a categorization of the rules by action type. That is, if each rule includes one or action types of which it may be applicable, then the number of rule comparisons may be reduced. In addition, certain rules may have already been applied and may be effectively inactivated for subsequent actions. For example, the current order of the application pages may have been determined by a set of rules when the job applicant initiates a job application for a given job, but that set of rules may not be reapplied on other actions taken during the job application process. If there is a negative determination (i.e., there are no applicable rules for the current job application action), then the workflow manager may automatically move processing to step 260 as described below. Otherwise, if there is a positive determination by workflow manager 120, then processing may automatically continue to step 220.

Then in step 220, a determination is made automatically by workflow manager 120 whether any services 190 should be performed in response to an applicability of any rules from step 210. This may include a qualification assessment of the job applicant to the job, an assessment whether the job applicant may be new to the application process which may initiate a training session with the job applicant, an assessment whether the job applicant may be submitting an excessive number of job applications in a short period of time, a comparison of information provided by the applicant against information stored in the applicant's profile, calendaring an appointment of the job applicant if certain conditions are met, etc. If there are multiple applicable rules that request services, then those services may be performed in a tiered order. For example, a qualification assessment service may be performed prior to a calendaring service. If there is a positive determination in step 220, the processing automatically continues to step 225 for workflow manager 120 to invoke the applicable services 190. Otherwise processing automatically continues to step 230 for workflow manager 120. Once the applicable services 190 have been invoked by workflow manager 120 and completed in step 225, processing also automatically continues to step 230 for workflow manager 120.

In step 230, a determination is made automatically by workflow manager 120 whether any of the applicable rules may modify the current job application process. For example, the applicable rules (rules identified as applicable in step 210 above) may include rule actions to modify the application process by, for example, adding, removing, or reordering the pages for completion by the job applicant for the current job. For another example, the applicable rules may include rule actions to promote the job applicant completing the job application or rule actions to discourage completion of the job application. Such encouragement may include removing pages less necessary or completion and discouragement may include various types of “friction” such as continually asking “are you sure” or other such impediments. Upon a positive determination in step 230 by workflow manager 120, processing automatically continues to step 235, otherwise processing continues to step 240. In step 235, workflow manager 120 automatically implements the rule actions of the applicable rules. In the case of multiple applicable rules, the rule actions may be performed automatically by workflow engine 120 in accordance with the rule tiers such as described above. Processing then automatically continues to step 240.

In step 240, a determination is made automatically by workflow manager 120 whether any of the applicable rules may instruct the workflow manager to redirect the job applicant to other available jobs or to implement other redirection actions. For example, an applicable rule of redirection, based partly on a qualification assessment in step 225 in response to that rule, may instruct the workflow manager to discourage the job applicant in step 235 and to encourage the job applicant to pursue other job applications. If a positive determination is made in step 240 by workflow manager 120, then processing automatically continues to step 245, otherwise processing automatically continues to step 250. In step 245, workflow manager 120 may automatically invoke certain services to identify alternative jobs which may better fit the job applicant's qualifications, then present those alternative jobs to job applicant 130 through user interface 135. Processing then automatically continues to step 250.

In step 250, a determination is automatically made by workflow manager 120 whether processing of the current application has been completed. If a positive determination, then processing ends in step 290, otherwise processing continues to step 260. Then in step 260, the current job application is automatically processed in accordance with the action, action type and content. For example, if the job applicant has completed a page in the job application, workflow manager may store the job applicant provided content from that job application page to job application database 168. Processing then automatically continues to step 270 where workflow manager determines whether the job application process of the current application has been completed. If there is a positive determination, then processing ends for the current job application in step 290, otherwise processing automatically returns to step 205 for receiving or detecting the next job applicant action through user interface 135.

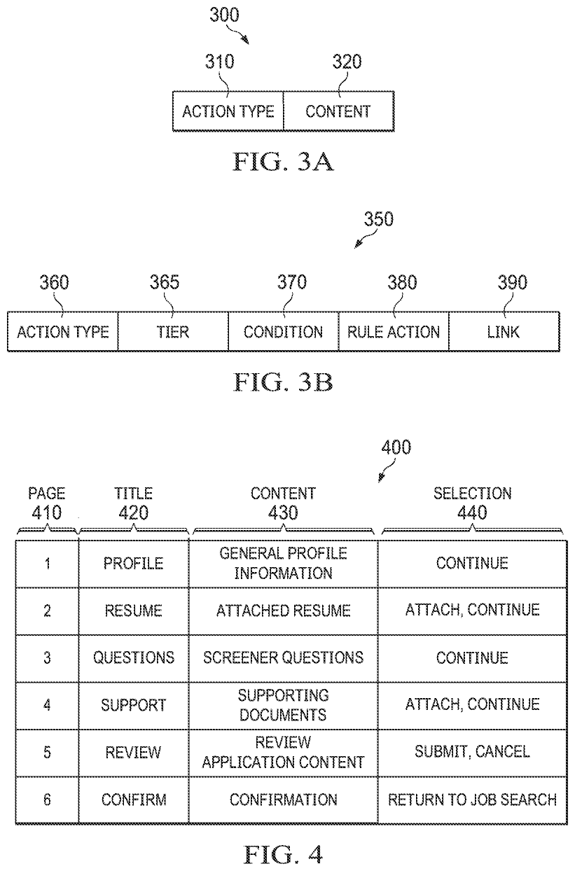

FIGS. 3A and 3B depict block diagrams of an action 300, a rule 350, and their components. Action 300 includes an action type 310 and content 320. Action type 310 includes information regarding the type of action taken by the job applicant on the job application. This may include initiating the job application, completing a particular field in the job application, completing a page of the job application, submitting the job application for submission, etc. Content 320 includes the content provided by the job applicant 130 on the job application through the job applicant user interface 135. This can include profile information regarding the job applicant, a resume, answers to screener questions, etc. Alternative embodiments may include additional or different components or fields, as may be appreciated by one of ordinary skill in the art.

Rule 350 includes an action type 360, a tier 365, a condition 370, a rule action 380, and a link 390. Action type 360 includes the action type for which the rule may apply. For example, some rules may apply only when the job applicant initiates the job application process, when the job applicant completes a certain page of the job application, when the job applicant completes any page of the job application, when the job applicant submits the completed application, etc. Action type applicability may be built into the condition of the rule, but by separately identifying the action type, the rules may be organized for checking only when those action types occur during the job application process. Tier 365 is a hierarchical categorization of the rules so as to avoid conflicts between the rules and to coordinate the rules. For example, some rules may generate different results depending on the order in which they are utilized. Condition 370 includes the conditions for the rule to apply to a given set of circumstances within the job application process. Rule action 380 includes the actions taken in response to the conditions being met. Essentially, condition 370 is the “if” of an if/then/else statement and rule action 380 is the “then/else’ of the if/then/else statement. Condition 380 may include multiple conditions such as “if A or B” and rule action may include multiple actions such as “then C and D, else E”. Link 390 allows for multiple rules to be linked together in series. For example, if a rule applies (i.e., the condition is met), then after the rule action has been taken another rule may be invoked. For example, a qualification assessment may be performed under certain conditions. Upon completion of the qualification assessment, an additional rule may be applied to determine whether to schedule an interview with that job applicant. Alternative embodiments may include additional or different components of fields, as may be appreciated by one of ordinary skill in the art.

FIG. 4 depicts a high level block diagram of a job application 400 which may be modified or redirected by configurable rules, in which various embodiments of the job application, dynamic workflow systems and processes may be implemented. Job application 400 may be completed by job applicant 130 through job applicant user interface 135 as managed by job application dynamic workflow management system 110 in accordance with the various rules stored in databases 150. In the present embodiment, job application 400 includes multiples pages 410, each page including a title 420, a set of content 430 and at least one selection 440 to move to another page or other selective action. Although shown as pages, alternative embodiments may utilize a single page with multiple sections or other types of displaying and collecting the job application information. In the present embodiment, page 1, entitled “Profile”, may request general profile information regarding the job applicant. This general profile may include contact information regarding the job applicant as well as other general information regarding the applicant. If the job applicant has logged into the system, previously stored information regarding the job applicant may be used to prefill much of this general profile information. The page 1 selection is to continue onto the next page. That is, when the job applicant has completed page 1 of the job application, the job applicant may select continue to proceed to page 2 of the job application. Page 2, entitled “Resume”, may include an opportunity for the job applicant to attach a resume to the job application. The page 2 selection is to either attach a document and/or continue to the next page. Page 2 may also allow the job applicant to include information regarding references. Page 3, entitled “Questions”, may include an opportunity for the job applicant to answer screener questions provided by the job provider. These screener questions may include questions that the job provider asks all job applicants for all jobs, questions that the job provider asks all job applicants for a given job type, and questions specific to the job for which the job applicant is applying. The page 3 selection is to continue onto the next page. Page 4, entitled “Support”, may include an opportunity for the job applicant to attach one or more documents to the job application. This document may include documentation of certain certifications, a driver's license (where applicable), etc. The page 4 selection is to either attach a document and/or continue to the next page. Page 5, entitled “Review”, may include an opportunity for the job applicant to review all the previously provided content prior to submitting the current job application for consideration. The page 5 selection is to cancel or submit. That is, the job applicant may decide to cancel the job application rather than to submit that job application for consideration. Page 6, entitled “Confirm”, is an informational page to the job applicant with content confirming that the job application was completed and forwarded to the job provider. The page 6 selection for the job applicant is to return to job searching. Alternative embodiments may include other pages, content and layout as may be appreciated by one of ordinary skill of the art.

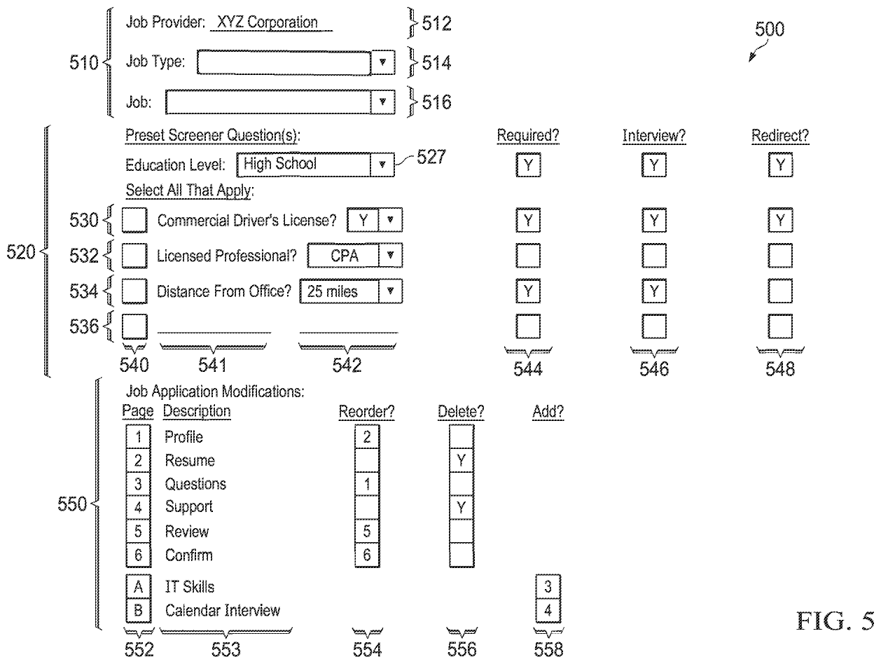

FIG. 5 provides a user interface page 500 for a job provider to configure rules for modifying the job application, for setting forth the conditions for redirecting the job applicant, and for other desired effects on the job application process, in which various embodiments of the job application, dynamic workflow systems and processes may be implemented. That is, a job provider representative 140 through job provider user interface 145 with rules configuration engine 124 to configure rules for a job application to be completed by job applicants 130. In an alternative embodiment, a job provider representative as rules. However, such an approach may require detailed understanding of the underlying system and corresponding extensive training. A system programmer may be able to program detailed system rules without the need for a constructed user interface for those purposes. Such a system programmer may also be able to take better advantage of machine learning 128 in creating and implementing such system rules.

User interface page 500 includes job information 510, screener question generator 520, and job application modifications 550. Job information 510 include identification of the job provider 512, identification of the job type 514 and identification of the job 516. Job provider 512 may be gleaned from the job provider representative logging into the user interface. Job type 514 may be identified from a pull down menu. Job 516 may also be identified from a pull down menu or it may be typed in if not available from the pull down menu. The selection of the job type may vary the choices of screener questions 520. Screener questions 520 may include a preset screener question 525 that is required by the job provider for all job applications. Preset screener question 525 may include a pull down menu 527 for the job provider representative to select the level needed to qualify for job 516. Screener questions 520 may also include other questions for selection include screener question 530, 532, 534 and 536. Screener questions 530, 532 and 534 may be predesignated and provided as options given the selection of job type above. Screener question 536 may be a more free form question which the job provider representative may complete. Screener questions 530, 532, 534 and 536 include a selection button 540, a brief description of the question 541, a pull down menu or other input 542 to select an answer desired, a requirement button 544, an interview button 546 and a redirect button 548. If selection button 540 is selected, then that question will be asked in the screener questions page of the job application. If required button 544 is selected, then the answer desired 542 is a requirement and a rule may be generated to implement that requirement. If interview button 546 is selected, then any job applicant meeting the desired answer for that screener question will be asked for an interview. That is, a rule is generated such that if the job applicant provides the desired answers to these selected screener questions, a calendaring service may be invoked to schedule an interview with the job applicant. If redirect button 548 is selected, then a job applicant not meeting the desired answer for that screener question may be redirected to a different job. That is, a rule is generated such that if the job applicant does not provide the desired answers to these questions, then a service for finding alternative jobs for the job candidate may be run and those alternatives may be provided to the job applicant in a pop up window.

User interface page 500 also includes job application modification 550. The standard pages 552, such as shown in FIG. 4 above, and their brief description 553 may be displayed along with two optional pages A-B which may be added. Also provided are a reorder selection 554 and a deletion selection 556 for pages 1-6, and an addition selection 558 for the two optional pages A-B. The job applicant representative may reorder the numbering of the job application pages numerically in reorder selection 554. In the present example, the screener questions are asked prior to the job applicants identifying themselves, the resume page and the supporting documents page are removed, and both optional questions A-B are included prior to the review and confirmation pages.

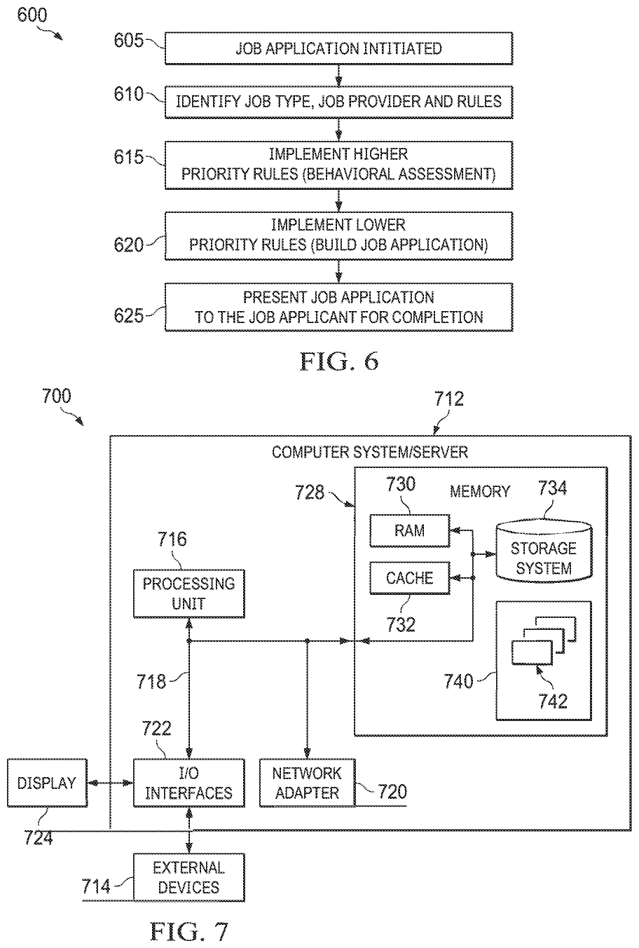

As the job provider completes the user interface, rules configuration engine 124 may generate rules implementing the selections made by the job provider representative. This may include system based conditions added to job provider based rules, such as described below. These rules may be included with action type so that they many are implemented as a job applicant initiates a job application, implemented as the job applicant works on the application, and/or implemented when the job applicant submits a completed job application. An example of the implementation of such rules upon initiation of a job application is shown in FIG. 6 below.

FIG. 6 provides a flow diagram 600 of a job application presented to a job applicant in accordance with the selection made by a job provider representative as shown in FIG. 5, in which various embodiments of the present disclosure may be implemented. The following is described including system rules and conditions that may be automatically added to the rules derived from input from job provider through user interface page 500. In a first step, responsive to a job applicant initiating a job application, a system rule with a high priority.

In a first step 605, a job applicant initiation of a job application for a job or a request thereof is detected or received. Job application workflow engine 120 may receive information identifying the job such as a unique job identifier. Then in step 610, workflow engine 120 automatically utilizes the job identifier to identify the job type, the job provider, and the applicable system and job provider rules from databases 150. In step 615, workflow engine 120 implements the highest priority (i.e., highest tier) rules applicable to a job application being initiated. In this embodiment, that would be a rule invoking a behavioral assessment service and receiving the results. In the present embodiment, the job applicant is determined by behavior assessment service to have performed several searches and viewed several jobs prior to initiating the present job application, so the job applicant may be viewed as a promising candidate given prior analysis performed by machine learning 128. Alternatively, if the job applicant had applied to the first five jobs the job applicant viewed, the job applicant may be viewed as a less promising candidate given prior analysis performed by machine learning 128.

In step 620, workflow engine 120 then automatically implements medium priority rules applicable to a job application being initiated. In the present embodiment, this would be to implement the rules regarding automatically generating a job application for the job applicant in accordance with the job provider rules derived from the job provider user interface such as shown in FIG. 5 above. In the present embodiment, with reference to FIG. 5, this would the questions page first, the profile page second, the IT skills page third, a calendaring page fourth (if applicable as described below), a review page fifth and a confirmation page sixth. Then, in step 625, workflow engine 120 starts presenting the generated job application from step 620 to the applicant 130 through job applicant user interface 135. In the present embodiment, there may be a system rule against calendaring an interview for a job applicant determined to be less than promising as described in step 615 above. In such a case, the job application would be dynamically and automatically generated with the questions page first, the profile page second, the IT skills page third, a review page fourth and a confirmation page fifth. Other such rules may apply to vary the pages presented to the job applicant.

Processing would then automatically continue such as shown above with reference to FIG. 2. However, there are nodes in the dynamic job application workflow process 200 whereby the job application workflow may be dynamically modified in accordance with information obtained from and about the job applicant by, for example, redirecting the job application to a new job application or reordering job application workflow of a current job application process. Depending on the answers to the screener page, the job applicant may be redirected to other jobs and, thus, other job applications. With reference to redirect questions 548 shown in FIG. 5, if the job applicant does not have a high school education or if the job applicant does not have a commercial driver's license (i.e., the rule conditions), then the job applicant may be directed to other jobs (i.e., the rule actions). With reference to interview questions 546, if the job applicant does not have a high school education, a commercial driver's license, or is not within 25 miles of the office (i.e., the rule conditions), then the calendaring page may be dynamically removed from the job application presented to the job applicant (i.e., the rule actions). The job application may still be submitted to the job provider and the job provider may then contact the job applicant for an interview at a later date. In an alternative embodiment, the job application may be generated “on the fly”. That is, each page is dynamically generated as the job applicant completes the prior page of the job application. Other such alternative embodiments may be appreciated by one of ordinary skill in the art.

FIG. 7 depicts a block diagram of an illustrative data processing system in which various embodiments of the present disclosure may be implemented. Data processing system 700 is one example of a suitable data processing system and is not intended to suggest any limitation as to the scope of use or functionality of the embodiments described herein. Regardless, data processing system 700 is capable of being implemented and/or performing any of the functionality set forth herein such as utilizing configurable rules for automatically managing dynamic on-line job applications.

In data processing system 700 there is a computer system/server 712, which is operational with numerous other computing system environments, peripherals, or configurations. Examples of well-known computing systems, environments, and/or configurations that may be suitable for use with computer system/server 712 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 712 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 712 may be practiced in distributed computing environments where tasks are performed by remote processing devices that are linked through a communications network. In a distributed computing environment, program modules may be located in both local and remote computer system storage media including memory storage devices. For example, the job application, dynamic workflow systems and processes may be implemented in a cloud computing environment, distributed or otherwise, which may be virtualized such as with the use of a hypervisor managing multiple nodes including virtual processors, virtual memory, etc.

As shown in FIG. 7, computer system/server 712 in data processing system 700 is shown in the form of a general-purpose computing device. The components of computer system/server 712 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 712 typically includes a variety of non-transitory computer system usable media. Such media may be any available media that is accessible by computer system/server 712, and it includes both volatile and non-volatile media, removable and non-removable media.

System memory 728 can include non-transitory computer system readable media in the form of volatile memory, such as random access memory (RAM) 730 and/or cache memory 732. Computer system/server 712 may further include other non-transitory removable/non-removable, volatile/non-volatile computer system storage media. By way of example, storage system 734 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 718 by one or more data media interfaces. Memory 728 may include at least one program product having a set (e.g., at least one) of program modules that are configured to carry out the functions of the embodiments. Memory 728 may also include data that will be processed by a program product.

Program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of the embodiments. For example, a program module may be software for utilizing configurable rules for automatically managing dynamic on-line job applications.

Computer system/server 712 may also communicate with one or more external devices 714 such as a keyboard, a pointing device, a display 724, etc.; one or more devices that enable a user to interact with computer system/server 712; and/or any devices (e.g., network card, modem, etc.) that enable computer system/server 712 to communicate with one or more other computing devices. Such communication can occur via I/O interfaces 722 through wired connections or wireless connections. Still yet, computer system/server 712 can communicate with one or more networks such as a local area network (LAN), a general wide area network (WAN), and/or a public network (e.g., the Internet) via network adapter 720. As depicted, network adapter 720 communicates with the other components of computer system/server 712 via bus 718. It should be understood that although not shown, other hardware and/or software components could be used in conjunction with computer system/server 712. Examples, include, but are not limited to: microcode, device drivers, tape drives, RAID systems, redundant processing units, data archival storage systems, external disk drive arrays, etc.

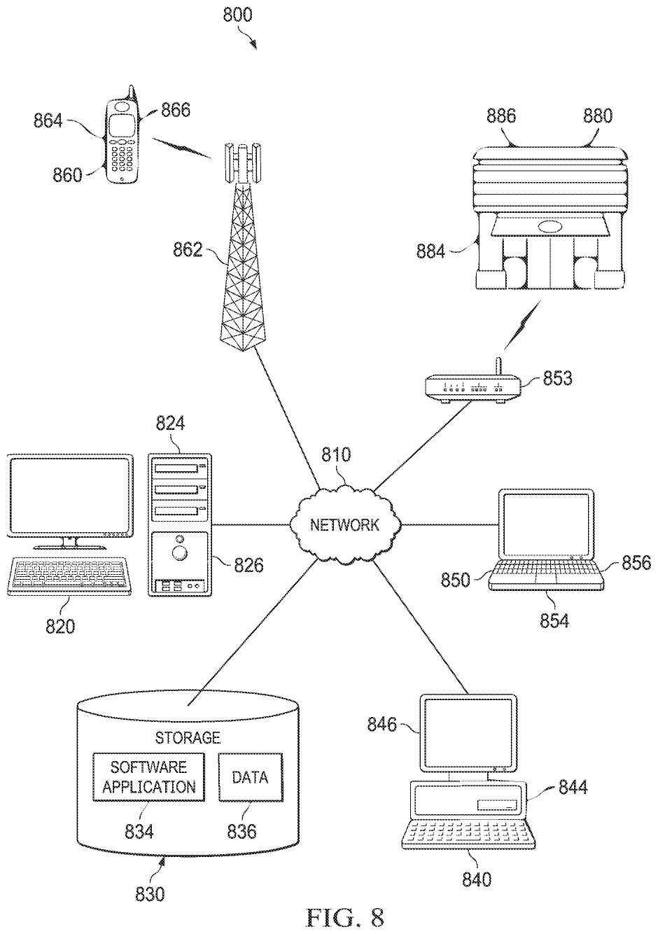

FIG. 8 depicts a block diagram of an illustrative network of data processing systems in which various embodiments of the present disclosure may be implemented. Data processing environment 800 is a network of data processing systems such as described above with reference to FIG. 7. Software applications such as for utilizing configurable rules for automatically managing dynamic on-line job applications may be processed on any computer or other type of data processing system in data processing environment 800. Data processing environment 800 includes network 810. Network 810 is the medium used to provide simplex, half duplex and/or full duplex communications links between various devices and computers connected together within data processing environment 800. Network 810 may include connections such as wire, wireless communication links, or fiber optic cables.

Server 820 and client 840 are coupled to network 810 along with storage unit 830. In addition, laptop 850 and facility 880 (such as a home or business) are coupled to network 810 including wirelessly such as through a network router 853. A mobile device 860 such as a mobile phone may be coupled to network 810 through a cell tower 862. Data processing systems, such as server 820, client 840, laptop 850, mobile device 860 and facility 880 contain data and have software applications including software tools processing thereon. Other types of data processing systems such as personal digital assistants (PDAs), smartphones, tablets and netbooks may be coupled to network 810.

Server 820 may include software application 824 and data 826 for utilizing configurable rules for automatically managing dynamic on-line job applications or other software applications and data in accordance with embodiments described herein. Storage 830 may contain software application 834 and a content source such as data 836 for utilizing configurable rules for automatically managing dynamic on-line job applications. Other software and content may be stored on storage 830 for sharing among various computer or other data processing devices. Client 840 may include software application 844 and data 846. Laptop 850 and mobile device 860 may also include software applications 854 and 864 and data 856 and 866. Facility 880 may include software applications 884 and data 886 on local data processing equipment. Other types of data processing systems coupled to network 810 may also include software applications. Software applications could include a web browser, email, or other software application for utilizing configurable rules for automatically managing dynamic on-line job applications.

Server 820, storage unit 830, client 840, laptop 850, mobile device 860, and facility 880 and other data processing devices may couple to network 810 using wired connections, wireless communication protocols, or other suitable data connectivity. Client 840 may be, for example, a personal computer or a network computer.

In the depicted example, server 820 may provide data, such as boot files, operating system images, and applications to client 840 and laptop 850. Server 820 may be a single computer system or a set of multiple computer systems working together to provide services in a client server environment. Client 840 and laptop 850 may be clients to server 820 in this example. Client 840, laptop 850, mobile device 860 and facility 880 or some combination thereof, may include their own data, boot files, operating system images, and applications. Data processing environment 800 may include additional servers, clients, and other devices that are not shown.

In the depicted example, data processing environment 800 may be the Internet. Network 810 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 800 also may be implemented as a number of different types of networks, such as for example, an intranet, a local area network (LAN), or a wide area network (WAN). FIG. 8 is intended as an example, and not as an architectural limitation for the different illustrative embodiments.

Among other uses, data processing environment 800 may be used for implementing a client server environment in which the embodiments may be implemented. A client server environment enables software applications and data to be distributed across a network such that an application functions by using the interactivity between a client data processing system and a server data processing system. Data processing environment 800 may also employ a service oriented architecture where interoperable software components distributed across a network may be packaged together as coherent business applications.

The job application, dynamic workflow systems and processes may be a system, a method, and/or a computer program product at any possible technical detail level of integration. The computer program product may include a computer readable storage medium (or media) having computer readable program instructions thereon for causing a processor to carry out aspects of the job application, dynamic workflow systems and processes.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the job application, dynamic workflow systems and processes may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the job application, dynamic workflow systems and processes.

Aspects of the job application, dynamic workflow systems and processes are described herein with reference to flowchart illustrations and/or block diagrams of methods, apparatus (systems), and computer program products according to embodiments of the job application, dynamic workflow systems and processes. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the job application, dynamic workflow systems and processes. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for utilizing configurable rules for automatically managing dynamic on-line job applications. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the job application, dynamic workflow systems and processes have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the job application, dynamic workflow systems and processes has been presented for purposes of illustration and description but is not intended to be exhaustive or limited to the job application, dynamic workflow systems and processes in the form disclosed. Many modifications and variations will be apparent to those of ordinary skill in the art without departing from the scope and spirit of the disclosure. The embodiment was chosen and described in order to best explain the principles of the job application, dynamic workflow systems and processes and the practical application, and to enable others of ordinary skill in the art to understand the job application, dynamic workflow systems and processes for various embodiments with various modifications as are suited to the particular use contemplated.

1. A method of automatically managing dynamic on-line job application workflow comprising:
receiving, from a first computer system of a job provider representative, configurable rules for presenting a job application to a job applicant;
receiving, from a second computer system of a job applicant, an initiation of the job application from the job applicant;
responsive to the initiation of the job application, automatically providing the job application to the second computer system of the job applicant in accordance with the set of configurable rules from the first computer system of the job provider representative;
receiving information regarding the job applicant; and
dynamically modifying the job application workflow presented to the second computer system of the job applicant in response to the job applicant.

2. The method of claim 1 wherein the information received regarding the job applicant is provided by the job applicant in the job application.

3. The method of claim 1 wherein the information received regarding the job applicant is obtained from a service evaluating on-line behavior of the job applicant.

4. The method of claim 1 further comprising supplementing the set of rules with conditions derived from machine learning of prior job applications and prior job applicant's on-line behavior.

5. The method of claim 1 further comprising:
responsive to receiving a completed job application from the second computer system of the job applicant, automatically assessing the information received regarding the job applicant in the completed job application to determine whether to interview the job applicant; and
responsive to a positive interview determination, automatically calendaring an interview with the job provider through the first computer system.

6. The method of claim 1 further comprising:
receiving a set of screener questions from the first computer system of the job provider representative including a set of rules regarding the requirement of answers to those questions by a job applicant; and
providing the screener questions to the second computer system of the job applicant for providing answers.

7. The method of claim 6 further comprising;
responsive to receiving the answers to the screener questions from the second computer system of the job applicant, automatically determining whether to redirect the job applicant to other jobs based on the set of rules regarding the requirement of answers to those questions; and
responsive to a positive determination of redirecting, automatically providing a set of alternative jobs to the second computer system of the job applicant.

8. A non-transitory, computer program product for automatically managing dynamic on-line job applications, the computer program product comprising a computer readable storage medium having program instructions embodied therewith, the program instructions processed by a processing circuit to cause the device to perform a method comprising the steps of:
receiving, from a first computer system of a job provider representative, configurable rules for presenting a job application to a job applicant;
receiving, from a second computer system of a job applicant, an initiation of the job application from the job applicant;
responsive to the initiation of the job application, automatically providing the job application to the second computer system of the job applicant in accordance with the set of configurable rules from the first computer system of the job provider representative;
receiving information regarding the job applicant; and
dynamically modifying the job application workflow presented to the second computer system of the job applicant in response to the job applicant.

9. The non-transitory, computer program product of claim 8 wherein the information received regarding the job applicant is provided by the job applicant in the job application.

10. The non-transitory, computer program product of claim 8 wherein the information received regarding the job applicant is obtained from a service evaluating on-line behavior of the job applicant.

11. The non-transitory, computer program product of claim 8 further comprising supplementing the set of rules with conditions derived from machine learning of prior job applications and prior job applicant's on-line behavior.

12. The non-transitory, computer program product of claim 8 further comprising:
responsive to receiving a completed job application from the second computer system of the job applicant, automatically assessing the information received regarding the job applicant in the completed job application to determine whether to interview the job applicant; and
responsive to a positive interview determination, automatically calendaring an interview with the job provider through the first computer system.

13. The non-transitory, computer program product of claim 8 further comprising:
receiving a set of screener questions from the first computer system of the job provider representative including a set of rules regarding the requirement of answers to those questions by a job applicant; and
providing the screener questions to the second computer system of the job applicant for providing answers.

14. The non-transitory, computer program product of claim 13 further comprising;
responsive to receiving the answers to the screener questions from the second computer system of the job applicant, automatically determining whether to redirect the job applicant to other jobs based on the set of rules regarding the requirement of answers to those questions; and
responsive to a positive determination of redirecting, automatically providing a set of alternative jobs to the second computer system of the job applicant.

15. A data processing system for automatically managing dynamic on-line job applications, the data processing system comprising:
a processor; and
a memory, coupled to the processor, storing program instructions which when executed by the processor perform operations comprising:
receiving, from a first computer system of a job provider representative, configurable rules for presenting a job application to a job applicant;
receiving, from a second computer system of a job applicant, an initiation of the job application from the job applicant;
responsive to the initiation of the job application, automatically providing the job application to the second computer system of the job applicant in accordance with the set of configurable rules from the first computer system of the job provider representative;
receiving information regarding the job applicant; and
dynamically modifying the job application workflow presented to the second computer system of the job applicant in response to the job applicant.

16. The data processing system of claim 15 wherein the information received regarding the job applicant is provided by the job applicant in the job application.

17. The data processing system of claim 15 wherein the information received regarding the job applicant is obtained from a service evaluating on-line behavior of the job applicant.

18. The data processing system of claim 15 further comprising supplementing the set of rules with conditions derived from machine learning of prior job applications and prior job applicant's on-line behavior.

19. The data processing system of claim 15 further comprising:
responsive to receiving a completed job application from the second computer system of the job applicant, automatically assessing the information received regarding the job applicant in the completed job application to determine whether to interview the job applicant; and
responsive to a positive interview determination, automatically calendaring an interview with the job provider through the first computer system.

20. The data processing system of claim 15 further comprising:
receiving a set of screener questions from the first computer system of the job provider representative including a set of rules regarding the requirement of answers to those questions by a job applicant; and
providing the screener questions to the second computer system of the job applicant for providing answers.

21. The data processing system of claim 20 further comprising;
responsive to receiving the answers to the screener questions from the second computer system of the job applicant, automatically determining whether to redirect the job applicant to other jobs based on the set of rules regarding the requirement of answers to those questions; and
responsive to a positive determination of redirecting, automatically providing a set of alternative jobs to the second computer system of the job applicant.

22. The method of claim 1:
wherein:
receiving, from a first computer system of a job provider representative further comprises:
receiving, from a first computer system of a job provider representative, configurable rules for presenting a job application to a job applicant and dynamically managing the on-line job application workflow, wherein the configurable rules are organized by action type categories, and each action type category represents a type of action by the job applicant during the job application workflow to reduce a number of rule comparisons;
receiving, from a second computer system of a job applicant further comprises:
receiving, from a second computer system of a job applicant, a job applicant action that includes an initiation of the job application from the job applicant;
receiving information regarding the further job applicant further comprises:
receiving further job applicant actions including receiving information regarding the job applicant;
further comprising:
responsive to each of the job applicant actions, comparing conditions of each of the configurable rules to determine which configurable rules within the action type categories apply to the job applicant action to reduce a number of rule comparisons relative to rule comparisons without the action type categories;
wherein:
dynamically modifying the job application workflow further comprises:
dynamically modifying the job application workflow presented to the second computer system of the job applicant in response to each of the job applicant actions and the configurable rules in the action type category that apply to each of the job applicant actions; and
further comprising:
modifying user interface data to represent a current state of the job application workflow as the job application workflow is dynamically modified.

23. The non-transitory, computer program product of claim 8:
wherein:
receiving, from a first computer system of a job provider representative further comprises:
receiving, from a first computer system of a job provider representative, configurable rules for presenting a job application to a job applicant and dynamically managing the on-line job application workflow, wherein the configurable rules are organized by action type categories, and each action type category represents a type of action by the job applicant during the job application workflow to reduce a number of rule comparisons;
receiving, from a second computer system of a job applicant further comprises:
receiving, from a second computer system of a job applicant, a job applicant action that includes an initiation of the job application from the job applicant;
receiving information regarding the further job applicant further comprises:
receiving further job applicant actions including receiving information regarding the job applicant;
further comprising:
responsive to each of the job applicant actions, comparing conditions of each of the configurable rules to determine which configurable rules within the action type categories apply to the job applicant action to reduce a number of rule comparisons relative to rule comparisons without the action type categories;
wherein:
dynamically modifying the job application workflow further comprises:
dynamically modifying the job application workflow presented to the second computer system of the job applicant in response to each of the job applicant actions and the configurable rules in the action type category that apply to each of the job applicant actions; and
further comprising:
modifying user interface data to represent a current state of the job application workflow as the job application workflow is dynamically modified.

24. The data processing system of claim 15:
wherein:
receiving, from a first computer system of a job provider representative further comprises:
receiving, from a first computer system of a job provider representative, configurable rules for presenting a job application to a job applicant and dynamically managing the on-line job application workflow, wherein the configurable rules are organized by action type categories, and each action type category represents a type of action by the job applicant during the job application workflow to reduce a number of rule comparisons;
receiving, from a second computer system of a job applicant further comprises:
receiving, from a second computer system of a job applicant, a job applicant action that includes an initiation of the job application from the job applicant;
receiving information regarding the further job applicant further comprises:
receiving further job applicant actions including receiving information regarding the job applicant;
further comprising:
responsive to each of the job applicant actions, comparing conditions of each of the configurable rules to determine which configurable rules within the action type categories apply to the job applicant action to reduce a number of rule comparisons relative to rule comparisons without the action type categories;
wherein:
dynamically modifying the job application workflow further comprises:
dynamically modifying the job application workflow presented to the second computer system of the job applicant in response to each of the job applicant actions and the configurable rules in the action type category that apply to each of the job applicant actions; and
further comprising:
modifying user interface data to represent a current state of the job application workflow as the job application workflow is dynamically modified.
